(19) United States
(12) Patent Application Publication
(10) Pub. No.: US 2013/0191906 A1
(43) Pub. Date: Jul. 25, 2013

(54) APPARATUS AND METHOD FOR SUPPORTING PORTABLE MOBILE VIRTUAL PRIVATE NETWORK SERVICE

(71) Applicants: Pyung-Koo PARK, Daejeon-si (KR); Jung-Sik KIM, Daejeon-si (KR); Sung-Back HONG, Daejeon-si (KR); Ho-Sun YOON, Daejeon-si (KR); Seong MOON, Daejeon-si (KR); Sun-Cheul KIM, Daejeon-si (KR); Young-Soo SHIN, Daejeon-si (KR); Sang-Jin HONG, Goyang-si (KR); Seung-Woo HONG, Daejeon-si (KR); Ho-Yong RYU, Daejeon-si (KR); Soon-Seok LEE, Daejeon-si (KR)

(72) Inventors: Pyung-Koo PARK, Daejeon-si (KR); Jung-Sik KIM, Daejeon-si (KR); Sung-Back HONG, Daejeon-si (KR); Ho-Sun YOON, Daejeon-si (KR); Seong MOON, Daejeon-si (KR); Sun-Cheul KIM, Daejeon-si (KR); Young-Soo SHIN, Daejeon-si (KR); Sang-Jin HONG, Goyang-si (KR); Seung-Woo HONG, Daejeon-si (KR); Ho-Yong RYU, Daejeon-si (KR); Soon-Seok LEE, Daejeon-si (KR)

(73) Assignee: Electronics and Telecommunications Research Institute, Daejeon-si (KR)

(21) Appl. No.: 13/619,302

(22) Filed: Sep. 14, 2012

(30) Foreign Application Priority Data
Jan. 20, 2012 (KR) 10-2012-0006971

(51) Int. Cl. G06F 21/20

(52) U.S. Cl. 726/15

(57) ABSTRACT

An apparatus and method for supporting a portable mobile VPN service are provided. The method accesses a public network to generate a security tunnel, maps the generated security tunnel and a VPN address, stands by for authentication of a mobile terminal which desires to access a VPN, authenticates a mobile terminal which desires to access the VPN, and assigns an internal address which is used in the VPN according to the authentication result.

### CROSS-REFERENCE TO RELATED APPLICATION

This application claims the benefit under 35 U.S.C. §119(a) of Korean Patent Application No. 10-2012-0006971, filed on Jan. 20, 2012, the entire disclosure of which is incorporated herein by reference for all purposes.

### BACKGROUND

1. Field

The following description relates to network communication technology, and more particularly, to virtual private network (VPN) service technology.

2. Description of the Related Art

Generally, a representative scheme that connects a head office and branch offices in a distributed business environment establishes a network with a leased line or a frame relay. However, the leased line is more costly than the frame relay.

Therefore, VPN technology has been proposed as a new network service which uses a public network, which is widely used and less costly than the leased line or the frame relay, such as the Internet. The VPN technology is technology that connects a remote terminal (branch office) and the head office by using the existing public network and thus virtually establishes a private communication network so as to enable stable communication with the outside.

A tunnel-based mobility support environment is an environment that supports mobility of a mobile terminal having a multi-network interface that can access a heterogeneous network by using a tunnel. Korean Patent Registration No. 10-0912535 discloses a method and system for supporting seamless handover using a wireless multi-interface.

### SUMMARY

The following description relates to an apparatus and method for supporting a VPN service for a mobile terminal in a tunnel-based mobility support environment.

In one general aspect, a method of supporting a portable mobile VPN service includes: accessing a public network to generate a security tunnel; mapping the generated security tunnel and a VPN address, and standing by for authentication of a mobile terminal which desires to access a VPN; authenticating a mobile terminal which desires to access the VPN; and assigning an internal address which is used in the VPN, according to the authentication result.

In another general aspect, an apparatus for supporting a portable mobile VPN service includes: a security tunnel controller configured to access a public network to generate a security tunnel; a routing table controller configured to map the generated security tunnel and a VPN address; an authenticator configured to authenticate a mobile terminal for supporting the VPN service when there is a mobile terminal which desires to access the VPN, after the routing table controller maps the generated security tunnel and the VPN address; and a VPN service controller configured to provide and manage the portable mobile VPN service for the mobile terminal in the tunnel-based mobility support environment.

Other features and aspects will be apparent from the following detailed description, the drawings, and the claims.

### BRIEF DESCRIPTION OF THE DRAWINGS

FIG. 1 is a reference diagram for describing a portable mobile VPN service support mechanism according to an embodiment of the present invention.

FIG. 2 is a reference diagram for describing a concept of a portable mobile VPN service according to an embodiment of the present invention.

FIG. 3 is a reference diagram showing a mapping routing table for describing an example of mapping between a security tunnel and a private address, according to an embodiment of the present invention.

FIG. 4 is a reference diagram for describing a security function of the portable mobile VPN service according to an embodiment of the present invention.

FIG. 5 is a reference diagram for describing a data flow between portable VPN sites according to an embodiment of the present invention.

FIG. 6 is a block diagram illustrating a VPN service support apparatus according to an embodiment of the present invention.

FIG. 7 is a flowchart illustrating a portable mobile VPN service method according to an embodiment of the present invention.

FIG. 8 is a detailed flowchart illustrating an authentication method for accessing a VPN according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the present invention will be described in detail with reference to the accompanying drawings. In the following description, when the detailed description of the relevant known function or configuration is determined to unnecessarily obscure the important point of the present invention, the detailed description will be omitted. Moreover, the terms that have been defined as described above may be altered according to the intent of a user or operator, or conventional practice. Therefore, the terms should be defined on the basis of the entire content of this specification.

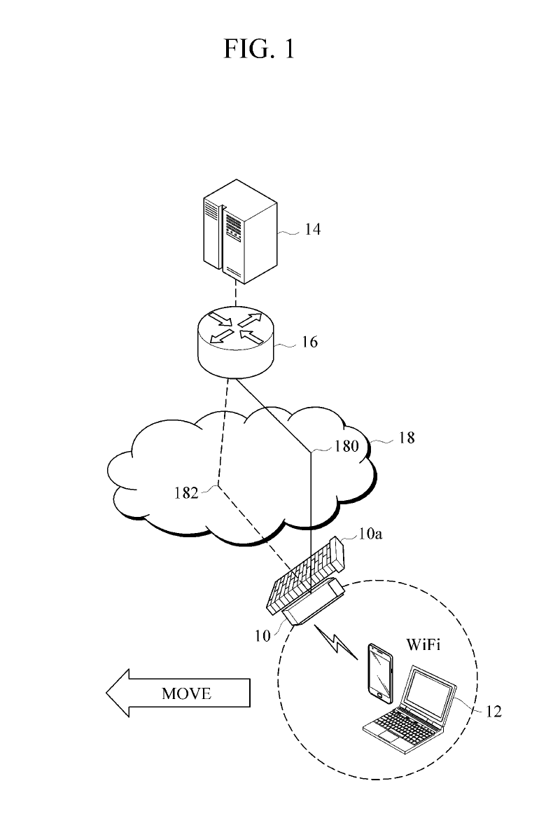

FIG. 1 is a reference diagram for describing a portable mobile VPN service support mechanism according to an embodiment of the present invention.

Referring to FIG. 1, a portable mobile VPN service support system according to an embodiment of the present invention includes a VPN service support apparatus 10, a mobile terminal 12, a fixed mobile convergence control (FMC) support server 14, and a gateway 16.

The present invention supports a portable mobile VPN service in a tunnel-based mobility support environment. The tunnel-based mobility support environment is an environment that supports seamless mobility for the mobile terminal 12 having a multi-network interface that can access a heterogeneous network, by using a tunnel. To support the portable mobile VPN service in operational connection with the tunnel-based mobility support environment, the present invention configures a mobile VPN site, and enables a portable VPN service for various mobile terminals in the VPN site. Furthermore, the present invention ensures stability for data of a private network over a public network 18 such as the Internet, for security access of mobile terminals.

The FMC support server 14 is a server that supports mobility service for mobile terminal users by using various networks. The gateway 16 is connected to the FMC support server 14 and forwards data. The gateway 16 may be replaced with a router, or configured together with the router.

The VPN service support apparatus 10 is disposed in the VPN, and supports a tunnel-based mobility service for various mobile terminals in the VPN site. To support the tunnel-based mobility service, an active tunnel 182 and a standby tunnel 180 for mobility are generated between the gateway 16 and the VPN service support apparatus 10. When the signal of the standby tunnel 182 is stronger than that of the active tunnel 180, the standby tunnel 180 is changed to an active tunnel, and data is transmitted through the changed active tunnel, whereupon a new standby tunnel is prepared. The VPN service support apparatus 10 may include a firewall 10a for security.

The mobile terminal 12 may be a mobile device that a user is capable of carrying and moving, and for example, may be a smart phone, a personal digital assistant (PDA), or a notebook computer. The mobile terminal 12 includes an access interface that can access Ethernet, HSDPA, WiBro, Wi-Fi, etc.

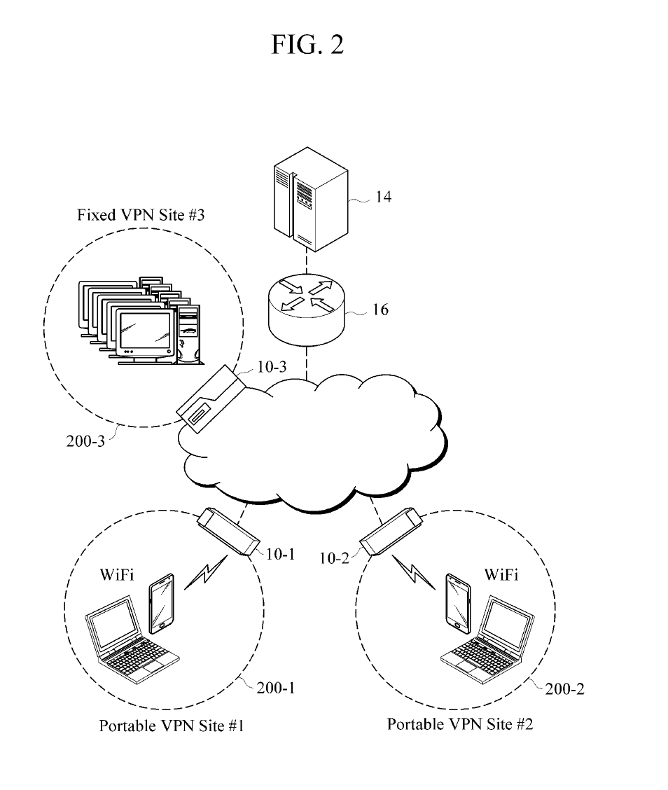

FIG. 2 is a reference diagram for describing a concept of a portable mobile VPN service according to an embodiment of the present invention.

Referring to FIG. 2, the VPN site includes a plurality of portable VPN sites 200-1 and 200-2, and a fixed VPN site 200-3. Each of the portable VPN sites 200-1 and 200-2 and fixed VPN site 200-3 is configured with a client in the tunnel-based mobility service. That is, each of a plurality of VPN service support apparatuses 10-1 and 10-2 configures the VPN as a Wi-Fi wireless network. Each of the VPN service support apparatuses 10-1 and 10-2 is configured with a client in the tunnel-based mobility service.

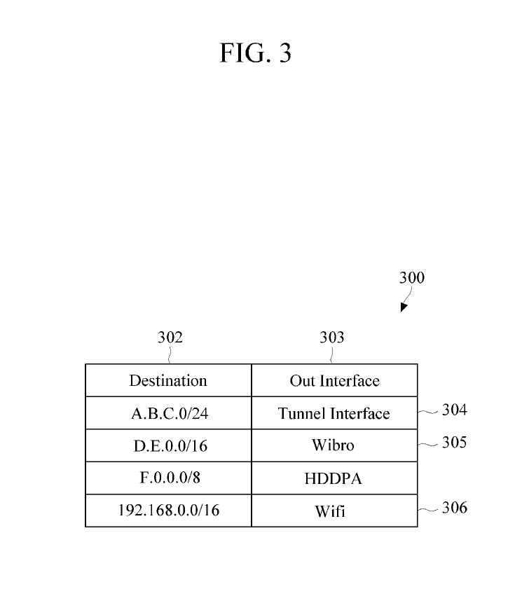

FIG. 3 is a reference diagram showing a mapping routing table for describing an example of mapping between a security tunnel and a private address, according to an embodiment of the present invention.

The VPN service support apparatus 10 maps a security tunnel (which has been generated through tunnel-based mobility service access) and a private address, and the mapping result is stored in the mapping routing table 300. The routing table 300, on which a relationship between the security tunnel and the private tunnel is mapped, is configured with a relationship between a destination address 302 and an output network interface 303. As an example, when the VPN service support apparatus 10 accesses the public network by using the WiBro 305, a default address is set to the WiBro 305. Subsequently, when the security tunnel is generated, Internet access is made through the WiBro 305, and the private address is mapped to a virtual tunnel interface 304. In this case, the private address is mapped to tunnel-based mobility support service protocol. Destination data other than the private address is transmitted to the public network instead of the tunnel interface 304.

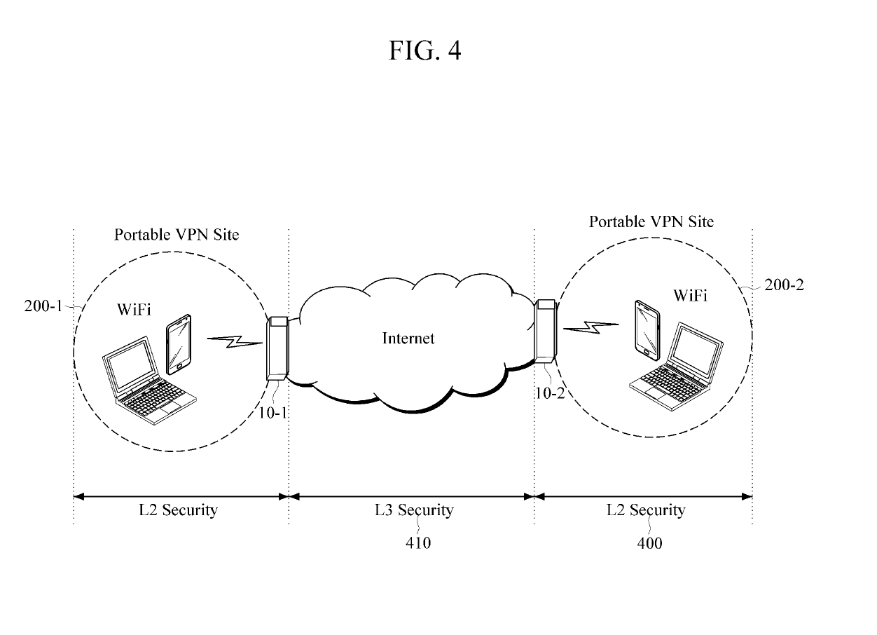

FIG. 4 is a reference diagram for describing a security function of the portable mobile VPN service according to an embodiment of the present invention.

Referring to FIG. 4, communication between the portable VPN sites 200-1 and 200-2 uses an L2 security function 400 in an internal Wi-Fi network. The public network uses an L3 security function 410. The L2 security function 400 may use security functions that are respectively provided from WEP, WPA-PSK, WPA2-PSK, and a general Wi-Fi network such as TKIP or AES using an encryption scheme. Also, the L3 security function 410 may use a security program such as Internet protocol security (IPSec).

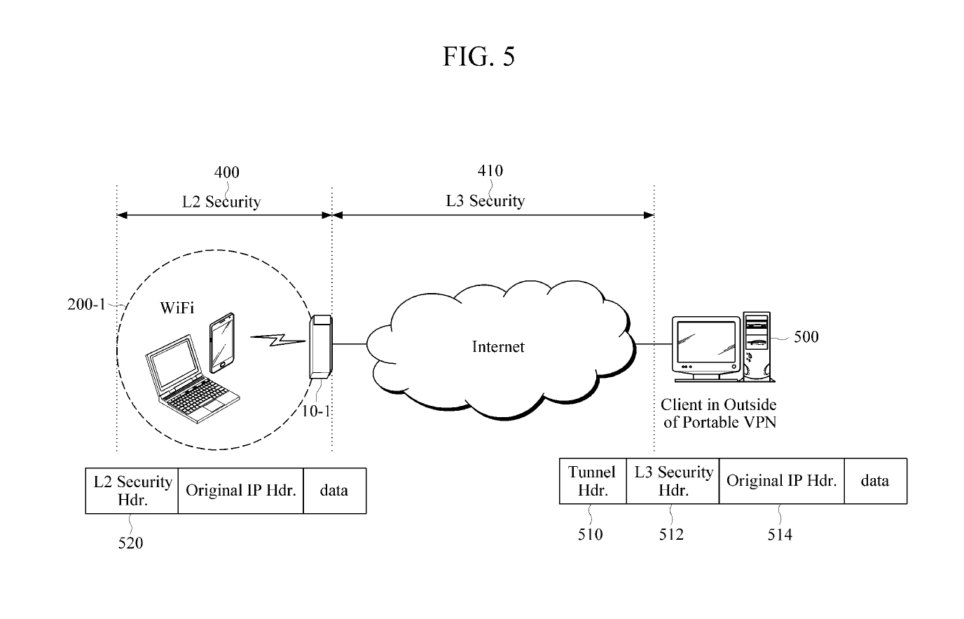

FIG. 5 is a reference diagram for describing a data flow between portable VPN sites according to an embodiment of the present invention.

Referring to FIG. 5, a client 500 accessing the public network such as the Internet transmits a tunnel header 510 and an L3 security header 512 to the public network, and simultaneously transmits data and an IP header 514 of the original data to the public network together. Then, the VPN service support apparatus 10-1 removes the tunnel header 510, processes the L3 security header 512, and transmits data to the private network 200-1. At this point, the VPN service support apparatus 10-1 transmits both the L2 security header 520 (which has been determined in accessing the private network 200-1) and data to a destination terminal.

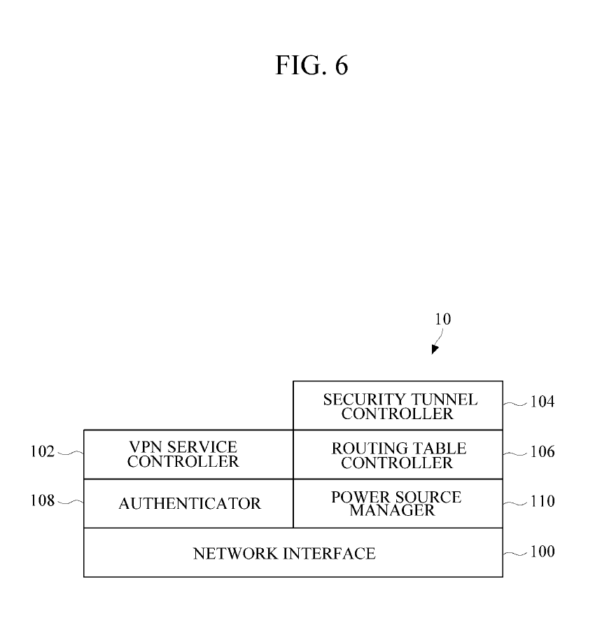

FIG. 6 is a block diagram illustrating the VPN service support apparatus 10 according to an embodiment of the present invention.

Referring to FIG. 6, the VPN service support apparatus 10 includes an interface 100 for accessing the public network or the private network in hardware, and a battery (not shown) for carrying. The network interface 100, for example, includes an HSDPA network interface or a WiBro network interface for accessing the public network, and includes a Wi-Fi network interface for accessing the private network. The VPN service support apparatus 10 may configure a VPN as a Wi-Fi wireless network, and is configured with a client in the tunnel-based mobility service.

The VPN service support apparatus 10 functionally includes a VPN service controller 102, a security tunnel controller 104, a routing table controller 106, an authenticator 108, and a power source manager 110.

The security tunnel controller 104 accesses the public network to generate a security tunnel. According to an embodiment, the security tunnel controller 104 selects a network interface for accessing the public network, accesses the public network by using the selected network interface, obtains authentication for the tunnel-based mobility service, and generates the security tunnel.

The routing table controller 106 maps a private network address and the security tunnel that has been generated by the security tunnel controller 104. An embodiment of the mapped routing table is illustrated in FIG. 3.

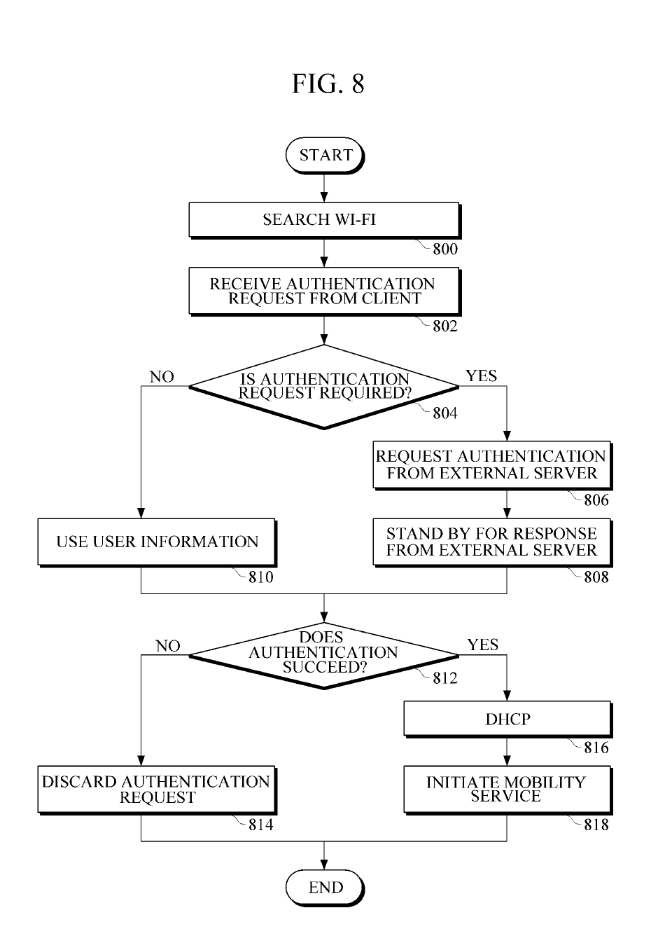

The authenticator 108 authenticates a mobile terminal that desires to access the VPN. According to an embodiment, when the mobile terminal that desires to access the VPN requests access authentication, the authenticator 108 authenticates the mobile terminal on the basis of internal authentication information. According to another embodiment, when the mobile terminal that desires to access the VPN requests access authentication, the authenticator 108 requests authentication from an external authentication server, and authenticates the mobile terminal according to a response from the external authentication server. An embodiment of the mobile terminal authentication of the authenticator 108 will be described in detail below with reference to FIG. 8.

The VPN service controller 102 provides and manages a portable mobile VPN service in the tunnel-based mobility support environment.

According to an embodiment, the VPN service controller 102 supports the portable mobile VPN service between mobile terminals that are in respective VPN sites. At this point, communication between the mobile terminals in the respective VPN sites uses the L2 security function in the VPN, and uses the L3 security function in the public network. An embodiment of this is illustrated in FIG. 4.

According to an embodiment, when a terminal in a VPN site accesses the public network with data that includes a tunnel header and an L3 security header, the VPN service controller 102 removes the tunnel header from the data, processes the L3 security header, and transmits the data to the VPN. Subsequently, when a destination terminal in another VPN site accesses the VPN, the VPN service controller 102 adds an L2 security header into data, and transmits the data to the destination terminal. An embodiment of this is illustrated in FIG. 5.

According to an additional embodiment, the VPN service support apparatus 10 further includes a battery (not shown), a power source manager 110 that manages a power source, and a memory (not shown) that is a data storage space. In this case, a user may carry the VPN service support apparatus 10, and use the memory as a personal storage space.

According to an additional embodiment, the VPN service support apparatus 10 further includes a wireless communicator (not shown) that supports wireless communication for mobile payment. In this case, the wireless communicator may use a near field communication (NFC) means. Therefore, the VPN service support apparatus 10 may be used for mobile payment such as credit card payment.

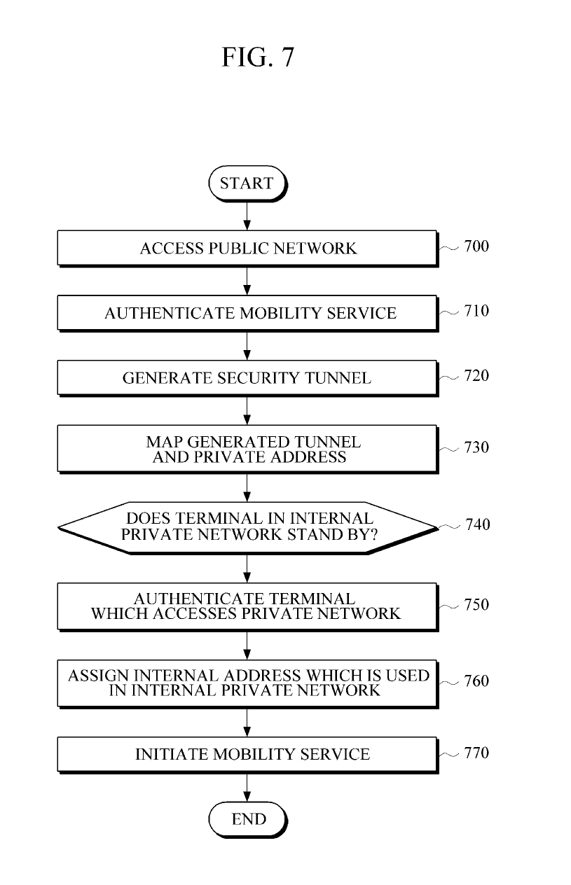

FIG. 7 is a flowchart illustrating a portable mobile VPN service method according to an embodiment of the present invention.

Referring to FIG. 7, the VPN service support apparatus 10 selects a network interface that is capable of accessing the public network simultaneously with booting, and accesses the public network in operation 700. The VPN service support apparatus 10 obtains authentication for supporting the tunnel-based mobility service for the mobile terminal in operation 710. When authentication succeeds in operation 710, the VPN service support apparatus 10 generates a security tunnel in operation 720.

Subsequently, the VPN service support apparatus 10 maps the generated security tunnel and a private address in operation 730, and stands by for access of the mobile terminal in the VPN in operation 740. In the standby, when another mobile terminal tries to access the VPN through Wi-Fi, the VPN service support apparatus 10 authenticates the other mobile terminal in operation 750. In this case, the VPN service support apparatus 10 may use internal authentication information or an external authentication server for terminal authentication. Subsequently, when the authentication of the other mobile terminal succeeds in operation 750, the VPN service support apparatus 10 assigns an internal address that is used in the VPN in operation 760, and thus a service-enabled state is achieved in operation 770.

FIG. 8 is a detailed flowchart illustrating an authentication method for accessing a VPN according to an embodiment of the present invention.

Referring to FIG. 8, a mobile terminal that desires access searches the Wi-Fi network in operation 800, and requests access authentication in operation 802. Then, the VPN service support apparatus 10 determines whether to use internal authentication information or request authentication from an external authentication server for access authentication in operation 804.

When the VPN service support apparatus 10 requests authentication from the external authentication server in operation 806, the VPN service support apparatus 10 waits for an authentication result from the external authentication server in operation 808. On the other hand, the VPN service support apparatus 10 may use the internal authentication information in operation 810. The internal authentication information, for example, may be user information such as employee identification number or resident registration number, or terminal information such as an media access control (MAC) address, a telephone number, an electronic serial number (ESN), a masker key, etc.

When the authentication result is failure to authenticate, the VPN service support apparatus 10 discards data regarding the authentication request in operation 814. However, when authentication succeeds, the VPN service support apparatus 10 internally assigns an IP address according to dynamic host configuration protocol (DHCP) in operation 816, and initiates service in operation 818.

According to an embodiment, the present invention ensures the continuity of the VPN service when a terminal is dynamically moving, and ensures seamless communication between VPN sites that are dynamically moving, thus overcoming limitations in the mobility and portability of the fixed VPN service. As an example, a dynamic VPN connection can be made between groups (which are in different countries on a business trip) and a group that is in a company.

Furthermore, the present invention may be applied to various terminals on the VPN, does not require correction of a terminal, and can use the tunnel-based mobility service. Also, the portable mobile VPN service may be applied to various terminals such as smart phones.

Furthermore, as an example of the application, a storage space may be added to the VPN service support apparatus and used as a mobile private storage space, and moreover, an NFC apparatus or a credit card terminal may be added to the VPN service support apparatus and used as a mobile payment system.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method in which a virtual private network (VPN) service support apparatus supports a portable mobile VPN service in a tunnel-based mobility support environment, the method comprising:
accessing a public network to generate a security tunnel;
mapping the generated security tunnel and a VPN address, and standing by for authentication of a mobile terminal which desires to access a VPN;
authenticating a mobile terminal which desires to access the VPN; and
assigning an internal address which is used in the VPN, according to the authentication result.

2. The method of claim 1, wherein the generating of a security tunnel comprises:
selecting a network interface for accessing the public network;
accessing the public network by using the selected network interface;
obtaining authentication for a tunnel-based mobility service, after accessing the public network; and
generating the security tunnel in response to successful authentication.

3. The method of claim 1, wherein authenticating the mobile terminal comprises:
receiving an access authentication request from the mobile terminal which desires to access the VPN; and
authenticating the mobile terminal on the basis of internal authentication information, according to the access authentication request.

4. The method of claim 1, wherein authenticating the mobile terminal comprises:
receiving an access authentication request from the mobile terminal which desires to access the VPN; and
requesting authentication from an external authentication server, and receiving a response from the external authentication server to authenticate the mobile terminal.

5. The method of claim 1, wherein the VPN is a Wi-Fi wireless network.

6. The method of claim 1, further comprising:
supporting the portable mobile VPN service between a plurality of mobile terminals which are in respective VPN sites,
wherein communication between the mobile terminals in the respective VPN sites uses an L2 security function in the VPN, and uses an L3 security function in the public network.

7. The method of claim 1, further comprising:
supporting the portable mobile VPN service between a plurality of mobile terminals which are in respective VPN sites,
wherein the supporting of the portable mobile VPN service comprises:
removing a tunnel header from data, processing an L3 security header, and transmitting the data to the VPN, when a terminal in a VPN site accesses the public network with the data which comprises the tunnel header and the L3 security header; and
adding an L2 security header into data, and transmitting the data to the destination terminal, when the destination terminal in another VPN site accesses the VPN.

8. An apparatus for supporting a portable mobile virtual private network (VPN) service in a tunnel-based mobility support environment, the apparatus comprising:
a security tunnel controller configured to access a public network to generate a security tunnel;
a routing table controller configured to map the generated security tunnel and a VPN address;
an authenticator configured to authenticate a mobile terminal for supporting the VPN service when there is a mobile terminal which desires to access the VPN, after the routing table controller maps the generated security tunnel and the VPN address; and
a VPN service controller configured to provide and manage the portable mobile VPN service for the mobile terminal in the tunnel-based mobility support environment.

9. The apparatus of claim 8, wherein the VPN service support apparatus configures a VPN as a Wi-Fi wireless network, and is configured with a client in a tunnel-based mobility service.

10. The apparatus of claim 8, wherein the security tunnel controller selects a network interface for accessing the public network, accesses the public network by using the selected network interface, and obtains authentication for a tunnel-based mobility service to generate the security tunnel.

11. The apparatus of claim 8, wherein when an access authentication request is received from the mobile terminal which desires to access the VPN, the authenticator authenticates the mobile terminal on the basis of internal authentication information.

12. The apparatus of claim 8, wherein when an access authentication request is received from the mobile terminal which desires to access the VPN, the authenticator requests authentication from an external authentication server, and receives a response from the external authentication server to authenticate the mobile terminal.

13. The apparatus of claim 8, wherein,
the VPN service controller supports the portable mobile VPN service between a plurality of mobile terminals which are in respective VPN sites, and
communication between the mobile terminals in the respective VPN sites uses an L2 security function in the VPN, and uses an L3 security function in the public network.

14. The apparatus of claim 8, wherein,
the VPN service controller supports the portable mobile VPN service between a plurality of mobile terminals which are in respective VPN sites,
when a terminal in a VPN site accesses the public network with data which comprises a tunnel header and an L3 security header, the VPN service controller removes the tunnel header from the data, processes the L3 security header, and transmits the data to the VPN, and
when a destination terminal in another VPN site accesses the VPN, the VPN service controller adds an L2 security header into data, and transmits the data to the destination terminal.

15. The apparatus of claim 8, further comprising:
a battery;
a power source manager; and
a memory, which is a data storage space.

16. The apparatus of claim 8, further comprising a wireless communicator configured to support wireless communication for mobile payment,
wherein the VPN service support apparatus is usable for mobile payment.
